(19) United States
(12) Patent Application Publication
(10) Pub. No.: US 2010/0063833 A1
(43) Pub. Date: Mar. 11, 2010

(54) Grocery store based weight loss plan

(76) Inventor: Judy L. Mahoney, Bethel Park, PA (US)

Correspondence Address: Judy L. Mahoney, 811 Red Barn Rd, Bethel Park, PA, 15102, US

(21) Appl. No.: 12/008,825

(22) Filed: Jan. 15, 2008

Related U.S. Application Data
(60) Provisional application No. 60/885,615, filed on Jan. 18, 2007.

(51) Int. Cl. G06Q 50/00

(52) U.S. Cl. 705/2

(57) ABSTRACT

A Nutritionally balanced weight loss program based in a grocery store setting that includes cholesterol screening and blood pressure monitoring, PCP involvement, meal plans, grocery shopping assistance, on-line support, counseling and support, and a health advisor.

I am claiming the benefit of the filing date of provisional application no. 60/885,615.

Nutritionally balanced grocery store based weight loss plan that Includes the following components:
1. Free cholesterol screening
2. BP checks
3. PCP notifications
4. Nutritionally balanced meal plans
5. Individually tailored programs
6. On-line group support
7. On-line progress tracking
8. On-line newsletter
9. Grocery shopping assistance
10. Counseling and support
11. Professional Advisor

### BACKGROUND OF THE INVENTION

On Feb. 11, 2004 the Federal Government issued a report of a 6 month study on obesity in America. The report uncovered an alarming trend. As stated in the report, “Today, 64 percent of all Americans are overweight and over 30 percent are obese; in 1988 through 1992 fewer than 56 percent were overweight and fewer than 23 percent of American adults were obese. The trends for children are even more worrisome. Recent research by the U.S. Centers for Disease Control and Prevention (CDC) shows that 15 percent of children and adolescents aged 6 to 19 are overweight, double the rate of two decades ago.”

The study panel, called the Obesity Work Group, was commissioned to prepare a report that outlines an action plan to cover critical dimensions of obesity. The goal of the group (OWG) is to help confront the problem of obesity in the United States and to help consumers lead healthier lives through better nutrition.

The OWG's recommendations are centered on the scientific fact that weight control is primarily a function of balance of the calories eaten and calories expended on physical and metabolic activity. The recommendations contained in this report therefore focus on a “calories count” emphasis for FDA actions.

Lifestyles in America contribute to the problem of obesity. As families are increasingly more busy and adults struggle to balance work and family demands, there is a tendency to select convenience foods. “Fast food” sources, such as hamburger chains, have lowered the nutritive value of our diets. Hydrogenized oils and excessive sodium are very pleasing to the palate, and as such, are promoted to increase sales through “suggestive selling” methods. Add salt to the fries and you'll sell more drinks. For today's family, places like McDonald's offer a quick meal, it's affordable, and the kids love it.

Another contributor to the problem of obesity is the availability of simple sugars. Processed foods contain empty calories that provide little or no nutritive value. Complex carbohydrates can provide energy while also providing vitamins, bulk, and minerals. Yet, when we're hungry and in a hurry, we often grab a chocolate candy bar. Ads like, “Give it a break . . . ” for KitKats or “Hunger attack . . . ” for Snickers, encourage this. So, our caloric intake often is more than we can burn. Our blood sugar level rises too quickly, our insulin response is to overcompensate, and we end up in a hunger cycle that fools us into needing to eat again.

So you see, for all of these reasons, nutritional balance suffers. So, our body's metabolic balance and its fat burning capacity are not optimized. We feel tired, lack concentration, and our performance wanes.

The government isn't the only entity focusing on losing weight. Weight loss is a multi billion dollar industry in the United States and throughout the world. Many people end up in a weight loss/gain rebound cycle. Modern lifestyles are set up for dietary failure.

Weight loss has been the impetus for many dietary programs over the last several decades. Nutritional supplements alone are a major industry. Some of these are meal replacement shakes like slim-fast and optifast. Some are in protein bar form, like “Zone” bars, “Edge” bars, “Advantage” bars, and many others.

Other type of weight loss supplements come in the form of pills. Some of these like ephedrine, have been targets of recent FDA investigation and determined to be potentially harmful. Ephedrine has been taken off the market, however, in the weeks leading to its ban, there was a ‘run’ on ephedrine and stores could not keep it on the shelves. The demand for any form of weight loss product is great.

Some approaches to weight loss are more organized and have more of a “social club” atmosphere. Weight watchers, one of the oldest weight loss programs, focuses on a point system for food and activity, while providing group support, motivational coaches, education and a line of low calorie packaged food items. Weight watchers requires an enrollment fee as well as weekly dues.

The Jenny Craig system of weight loss is similar to weight watchers in that it is social in nature, provides education and coaching. However, instead of just a system of point tracking, the program provides a full meal plan. This is for a fee, however, and can be tracking, the program provides a full meal plan. This is for a fee, however, and can be quite costly. There is little flexibility in the diet.

The nutra-system plan is also a plan that provides prepared meals for a fee. But, like Jenny Craig, the plan is not designed with families in mind. The over weight member would not be able to have the same meals as the rest of the family. And again, the meal plan can be quite costly.

### DETAILED DESCRIPTION

Wouldn't it be great if there were a weight loss plan that addressed the overweight consumer's needs beyond any of the other weight loss plans? How about if that plan provided convenience and saved the consumer time by assisting with weekly grocery shopping? And what if the cost of that plan was little more than weekly grocery spending? And then, tailor the plan to all family members at the same time, even the children? Lets not stop there, let's draw in the family doctor, making sure that everyone includes their MD to oversee their progress. We'll throw in weekly blood pressure checks and a free cholesterol screening. Then, let's give our consumers a place to track their progress, discuss their concerns and share tips and recipes. Health professionals, who can answer questions and concerns and educate the consumer on a one to one basis, should manage the program.

By mapping the process we can get a clearer picture of how this plan works. Imagine you are the customer. You hear about the new grocery store diet program and come into the store to sign up.

1^{st} you meet with the nurse who is managing the program at your store. The nurse explains the program, and has you complete the necessary forms, and fill out a brief health history. The nurse explains about calorie requirements and you discuss your weight goals. You agree n a weight range, activity goal and a calorie level. You talk about the meal plans. The nurse draws your blood for cholesterol levels, and you take your blood pressure at the BP check station. Your weight, BP and calorie goals are recorded in the computer under your “Grocery” card. You get your internet access code, and list your PCP. Your blood is sent to the lab and you get your'meal plan and newsletter for the week. When complete, the lab results are sent to your PCP. You agreed to take responsibility to follow up with your PCP and for monitoring your blood pressure.

The following week you come in to the store, you weigh in and take your blood pressure. Your data is recorded in your record. You log on the web site and can see your progress tracked there. You can also access this from a remote location. You print out this week's copy of the meal plan. You take your cart and proceed to the produce section where this week's choices are clearly identified. A large note will tell you how many to choose. For instance, choose 2 of 5. This way, if you don't like green beens for instance, you may decide t choose zucchini instead. These choices will be seasonal and most affordable. Then, you proceed to the meat section where your choices are again identified. When you have completed your choices, you continue your shopping by selecting your bonus calories. Your meal plan will provide suggestions, i.e. you can make the most of your calorie budget by selecting Skinny Cow ice cream bars, or Pop Secret popcorn, or pre-cut veggies, etc. Calorie content of certain items can be identified (advertised) throughout the store.

Through this program, individuals can participate in a well monitored and supervised diet plan which is nutritionally sound, as part of their routine grocery shopping experience. In addition, the individual has their weekly meal planning done. The dieter can eat the same meals as other family members and have more control over their time as well.

1. What I claim as my invention is a nutritionally balanced weight loss plan delivered in a grocery store setting that is comprised of the following steps:
The participant meets with a health professional to sign up and complete a health history.
The health professional educates the participant about calorie requirements and weight goals.
The participant agrees to a weight goal, activity goal, and a calorie level.
The participant has their weight checked and blood drawn and for cholesterol levels.
The participant checks their blood pressure at the Blood Pressure check station.
The participant's blood pressure, current weight and goals are recorded in the computer under their “grocery card”.
The participant gets an internet access code and lists their PCP.
The participant agrees to follow up with their PCP regarding blood pressure and lab results.
The participant's blood is analyzed and the results sent to the member and their PCP.
The participant gets a weekly meal plan and completes their weekly shopping with the assistance of identified items throughout the store.
The participant returns each week for weights, and blood pressure checks, and a weekly meal plan.
The participant tracks their progress on-line or in the store.
The participant receives support from a weekly newsletter, available health counseling, online resources and discussion groups.
